(19) United States
(12) Patent Application Publication
(10) Pub. No.: US 2022/0193687 A1
(43) Pub. Date: Jun. 23, 2022

(54) Apparatus for Pulverizing Compressed Thermal Insulation

(71) Applicant: Troyer Brothers, Inc., Decatur, IN (US)

(72) Inventors: Marcus C. Troyer, Bluffton, IN (US); John R. McAfee, Bluffton, IN (US)

(73) Assignee: Troyer Brothers, Inc., Decatur, IN (US)

(21) Appl. No.: 17/130,797

(22) Filed: Dec. 22, 2020

(51) Int. Cl. B02C 4/30

(52) U.S. Cl. CPC B02C 4/30; B02C 4/286

(57) ABSTRACT

An apparatus for decompressing/pulverizing and fluffing up bales of compressed thermal insulation includes grinding wheel and a grinding die adjacent thereto thereby forming a gap therebetween. The grinding wheel is constructed with a plurality of plane members cut from flat steel material and stacked longitudinally about a rotatable shaft. The plane members each include a perimeter surface which together form the grinding wheel mantle surface and protrusions thereon. Coupling rods extend through aligned holes in the stacked plane members and retain the plane members in their stacked positions. The grinding die is constructed with a plurality of die plates cut from flat steel material and which are stacked longitudinally. The die plates each include an abutment surface which together form the grinding die surface and protrusions thereon. Coupling rods similarly extend through aligned holes in the stacked die plates and retain the die plates in their stacked positions.

### BACKGROUND OF THE INVENTION

### 1. Field of the Invention

The present invention relates to the field of apparatus and methods of pulverizing/decompressing and fluffing up cellulose and other types of loose fill thermal insulation which has previously been compressed into a cuboids for transport. More particularly, the present invention relates to the construction and assembly of a grinding wheel and a grinding die utilized within insulation pulverizing/decompressing apparatus.

### 2. Background

So as to maximize heat resistance, cellulose and other loose fill type thermal insulation is required to have low density and essentially be “fluffy” when placed in use. Consequently, it is lightweight relative to its volume. For minimizing storage and transportation costs thereof, the insulation is compressed, typically into cuboid shapes/bales which are substantially more dense and are easily stackable. Accordingly, prior to using the insulation as needed or desired, the bales of compressed insulation must be decompressed/pulverized and “fluffed up” into its low density high-volume state.

In this regard, apparatus have been devised for decompressing/pulverizing and fluffing up cellulose and other types of loose fill thermal insulation. For example, Bynelius, US 2015/0102143, discloses an apparatus of this character wherein compressed bales of insulation are forced into a rotatably driven grinding wheel for initially breaking apart/grinding the compressed insulation from the bale. An arc shaped stationary grinding die is located adjacent the grinding wheel thereby forming a gap there between and, after the insulation is ground from the bale, it is pushed/forced into and through the gap. The grinding wheel mantle/exterior face and the arc shaped grinding die are provided with protrusions/ridges whereby, as the insulation is received and forced through the gap, it is thereby further pulverized and fluffed up into the desired low density high-volume state for use as insulation.

In addition to the size and shape of the gap, it has been found that the size, shape and location of the protrusions and the valleys/indentations therebetween on the grinding wheel and on the arc shaped grinding die greatly influence the efficiency and efficacy of the apparatus. However, the current methods of constructing the grinding wheel and the arc shaped die, typically by welding the protrusions/ridges on the grinding wheel mantle surface and on the grinding die surface, do not readily lend themselves to effectively and efficiently creating protrusions and valleys/indentations therebetween as may be needed or desired.

Accordingly, a need exists for an improved apparatus for pulverizing and fluffing up compressed insulation wherein the rotatably driven grinding wheel and the stationary grinding die adjacent thereto, and the size, shape and location of the protrusions and the valleys/indentations therebetween may be accurately, reliably and efficiently constructed and assembled.

### SUMMARY OF THE INVENTION

The present invention overcomes the disadvantageous of prior apparatus for pulverizing compressed thermal insulation by constructing and assembling the grinding wheel and the grinding die thereof by using a plurality of plane members and die plates which are formed by cutting out of flat steel material. The plane members each include a perimeter surface, and the grinding wheel is assembled and constructed by longitudinally stacking a plurality of the plane members about the wheel axis of rotation whereby the perimeter surfaces of the stacked plane members together form the grinding wheel mantle surface along with the protrusions and the valleys/indentations therebetween. The die plates each include an abutment surface and the stationary grinding die is assembled and constructed by longitudinally stacking a plurality of the die plates whereby the abutment surfaces of the stacked die plates together form the grinding die surface along with the protrusions and the valleys/indentations therebetween.

In one form thereof, the present invention is directed to an apparatus for pulverizing compressed insulation by placing the compressed insulation in contact with a grinding wheel having a mantle surface circumscribing and being rotatable about an axis of rotation and having a plurality of protrusions arranged on the mantle surface. The grinding wheel includes a plurality of stacked plane members circumscribing and being rotatable about the axis of rotation; each plane member includes a perimeter surface; and, the perimeter surfaces of the stacked plane members together form the grinding wheel mantle surface and protrusions.

Preferably, the plane members include apertures defining spokes extending radially from the axis of rotation towards the perimeter surface and/or a solid plate extending from the axis of rotation towards the perimeter surface.

A rotatably driven shaft can be coaxially aligned with the axis of rotation and the plane members can be coupled to the shaft whereby they are rotatably driven. A plurality of coupling rods preferably extend perpendicular to and through aligned holes in the plurality of stacked plane members whereby the plane members are retained in their stacked position. The plane members are preferably formed by cutting out of flat steel material. The perimeter surface of each stacked plane member can be arranged relative to the perimeter surfaces of the other stacked plane members whereby the protrusions on and along the mantle surface form one or more of a spiral shape, a V-shape, a multiple V-shape, a sinusoidal shape, a multiple arch shape and a multiple staggered longitudinal lines shape.

The rotatably driven shaft is coaxially aligned with the axis of rotation, and the shaft preferably extends perpendicular to and through aligned openings in the plurality of stacked plane members, whereby the plane members are coupled to the shaft and are thereby rotatably driven. The aligned openings of the plane members more preferably include a noncircular shape and the shaft includes a mating noncircular shape portion, whereby the plane members are coupled to the shaft.

Yet more preferably, a grinding die is also provided having a die surface with a plurality of die protrusions arranged thereon. The die surface and the grinding wheel mantle surface are adjacent one another and form a gap therebetween wherethrough insulation is received and is further pulverized. The grinding die includes a plurality of stacked die plates. Each die plate includes an abutment surface, and the abutment surfaces of the stacked die plates together form the grinding die surface and protrusions.

A plurality of coupling rods preferably extend perpendicular to and through aligned holes in the plurality of stacked die plates whereby the die plates are retained in their stacked position. The die plates are preferably formed by cutting out of flat steel material. The abutment surface of each stacked die plate can be arranged relative to the abutment surfaces of the other stacked die plates whereby the protrusions on and along the die surface form one or more of a V-shape, a V-shape with staggered protrusions, a multiple V-shape, a spiral shape, a sinusoidal shape, a multiple arch shape and a multiple staggered longitudinal lines shape.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of an apparatus for pulverizing compressed thermal insulation constructed in accordance with the principles of the present invention;

FIG. 2 is another perspective view of the apparatus shown in FIG. 1;

FIG. 3 is a cross section view of the apparatus taken along line 3-3 of FIG. 2;

FIG. 4 is a perspective view of the grinding head unit of the apparatus shown in FIG. 1 and showing, in partial cross-section, the grinding wheel and the grinding die therein constructed in accordance with the principles of the present invention;

FIG. 5 is a perspective view of the grinding head unit of the apparatus taken along line 3-3 of FIG. 2;

FIG. 6 is a perspective partial exploded view of the grinding wheel;

FIG. 7 is a perspective partial exploded view of the grinding die;

FIG. 8 is a perspective exploded view of the grinding wheel;

FIG. 9 is a side elevation view of the grinding wheel;

FIG. 10 is a cross section view of the grinding wheel taken along line 10-10 of FIG. 9;

FIG. 11 is a cross section view of the grinding wheel taken along line 11-11 of FIG. 9;

FIG. 12 is a perspective exploded view of the grinding die;

FIG. 13 is a perspective view of a grinding die wherein the abutment surfaces of the stacked die plates are arranged and form a grinding die surface with protrusions having a V-shape with staggered protrusions;

FIG. 14 is a perspective view of a grinding die wherein the abutment surfaces of the stacked die plates are arranged and form a grinding die surface with protrusions having a V-shape;

FIG. 15 is a perspective view of a grinding die wherein the abutment surfaces of the stacked die plates are arranged and form a grinding die surface with protrusions having a multiple V-shape;

FIG. 16 is a perspective view of a grinding die wherein the abutment surfaces of the stacked die plates are arranged and form a grinding die surface with protrusions having a longitudinally extending spiral shape;

FIG. 17 is a perspective view of a grinding die wherein the abutment surfaces of the stacked die plates are arranged and form a grinding die surface with protrusions having a sinusoidal shape;

FIG. 18 is a perspective view of a grinding die wherein the abutment surfaces of the stacked die plates are arranged and form a grinding die surface with protrusions having a multiple arch shape;

FIG. 19 is a perspective view of a grinding die wherein the abutment surfaces of the stacked die plates are arranged and form a grinding die surface with protrusions having a multiple staggered longitudinal lines shape;

FIG. 20 is a perspective view of a grinding wheel wherein the perimeter surfaces of the stacked plane members are arranged and form a grinding wheel mantle surface with protrusions having a longitudinally extending spiral shape;

FIG. 21 is a perspective view of a grinding wheel wherein the perimeter surfaces of the stacked plane members are arranged and form a grinding wheel mantle surface with protrusions having a single V-shape;

FIG. 22 is a perspective view of a grinding wheel wherein the perimeter surfaces of the stacked plane members are arranged and form a grinding wheel mantle surface with protrusions having a multiple V-shape;

FIG. 23 is a perspective view of a grinding wheel wherein the perimeter surfaces of the stacked plane members are arranged and form a grinding wheel mantle surface with protrusions having a sinusoidal shape;

FIG. 24 is a perspective view of a grinding wheel wherein the perimeter surfaces of the stacked plane members are arranged and form a grinding wheel mantle surface with protrusions having a multiple arch shape; and,

FIG. 25 is a perspective view of a grinding wheel wherein the perimeter surfaces of the stacked plane members are arranged and form a grinding wheel mantle surface with protrusions having a multiple staggered offset longitudinal lines shape.

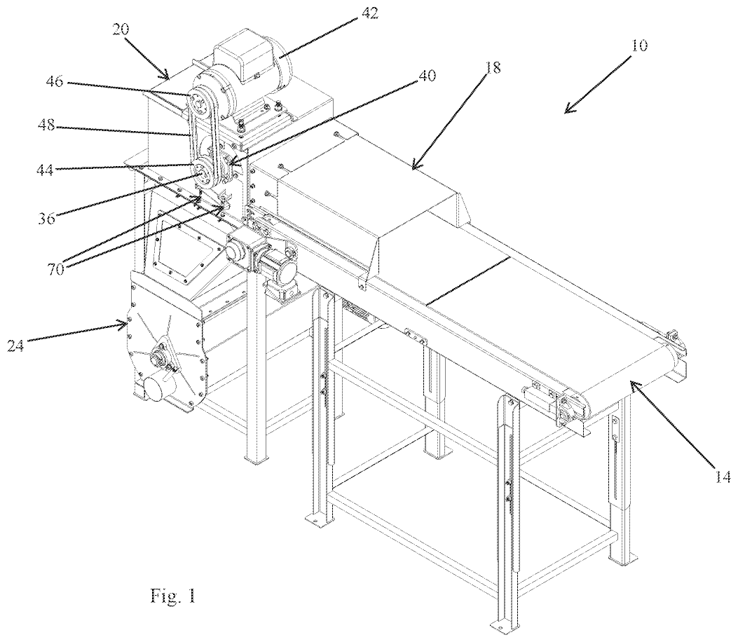

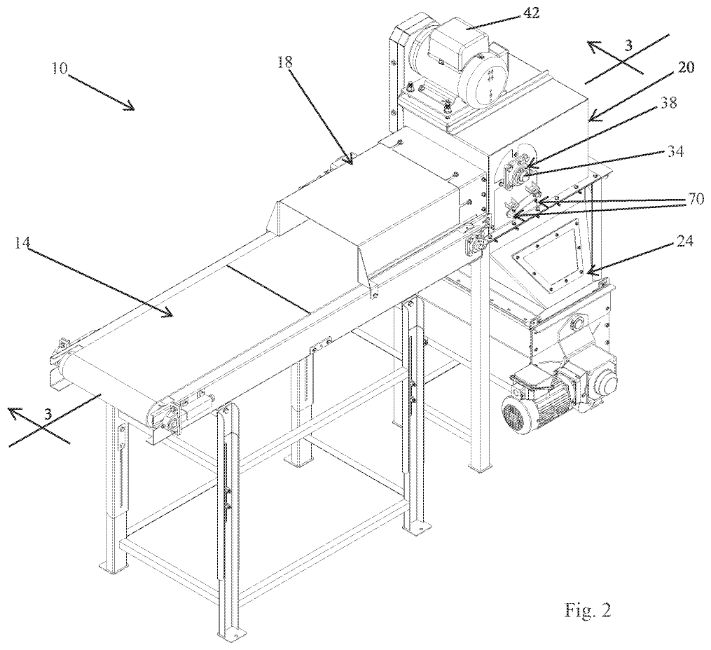

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

A compressed thermal insulation pulverizing apparatus constructed in accordance with the principles of the present invention is shown and designated in the drawings by the numeral 10. Apparatus 10 functions to essentially grind and pulverize/decompress and fluff up insulation which has previously been compressed in a known and customary manner into bales 12 for transport. The bales 12 are typically cuboid shaped and comprise thermal cellulose type insulation, although other shapes and insulation materials can be utilized with the apparatus 10. After pulverizing/decompressing, the insulation is typically transported via an air hose (not shown) and/or other means, in a known and customary manner, and sprayed for use as needed or desired.

Apparatus 10 includes a conveyor 14 adapted to carry the compressed insulation bales 12, as indicated by arrow 16, through a safety shield 18 and into a grinding head unit 20. The bales 12 are pulverized/decompressed in the grinding head unit 20 and the resulting fluffed up low density insulation 22 then drops and/or is sucked into the collection basin 24 there below as indicated by arrow 26. The fluffed-up insulation 22 is then transported via an air hose (not shown) and/or other means, in a known and customary manner, from the collection basin 24 to a desired location whereat it is sprayed for use as needed or desired.

The grinding head unit 20 includes a rotatably driven grinding wheel 28 and a grinding die 30 which together function, as mentioned herein above, to essentially grind and pulverize/decompress and fluff up the compressed/baled insulation 12. The grinding wheel 30 is rotatably carried on a shaft 32 which is journaled at its terminal ends 34, 36 within respective bearings 38, 40. One terminal end 36 of shaft 32 is coupled to a motor 42 via pulleys/sheaves 44, 46 and belts 48. Accordingly, shaft 32 and grinding wheel 28 are rotatably driven, as indicated by arrows 52, about an axis of rotation 50 which is generally perpendicular to the direction of travel of the insulation 12 on conveyor 14 as indicated by arrow 16.

The grinding wheel 28 has a mantle exterior surface 54 which is preferably cylindrical shaped, and which circumscribes and is rotatable about the axis of rotation 50/shaft 32. The mantle surface 54 is shaped having a plurality of protrusions 56 and valleys/indentations 58 there between. The grinding die 30 has a die surface 60 which is preferably generally arcuate/arch shaped with a radius from the axis of rotation 50 which is larger than the radius from the axis of rotation 50 to the mantle surface 54. The die surface 60 is similarly shaped having a plurality of protrusions 62 and valleys/indentations 64 there between.

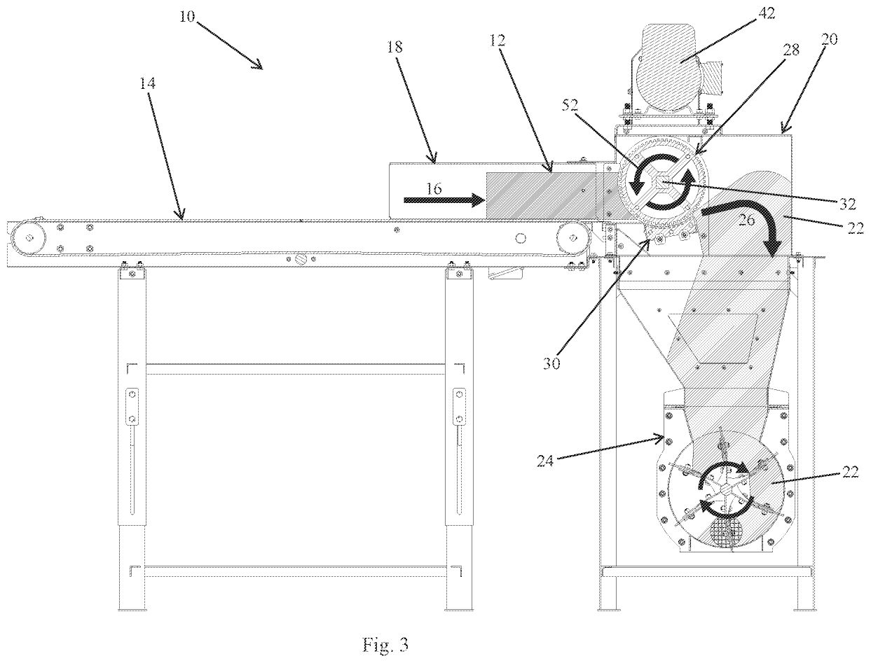

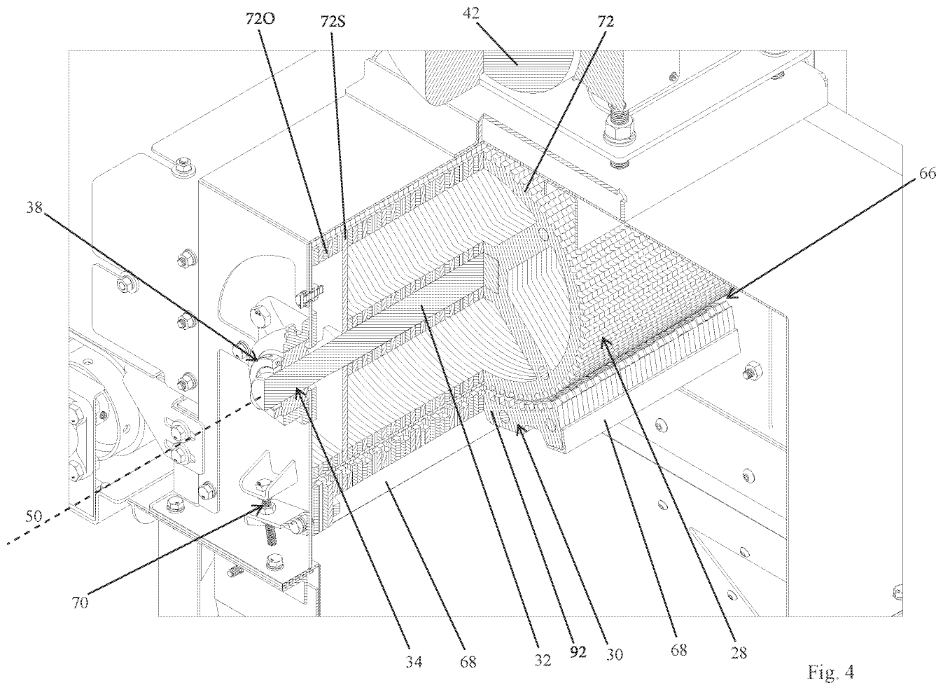

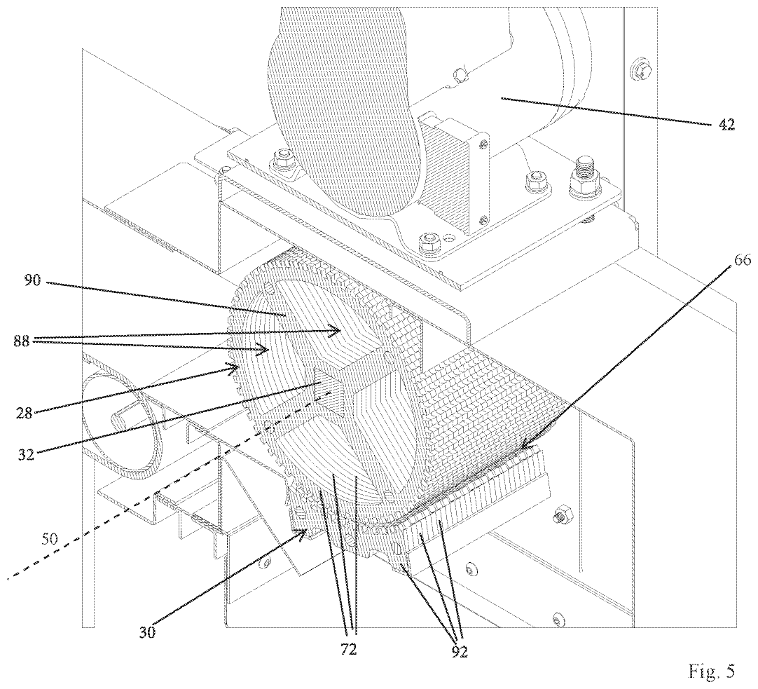

As best seen in FIGS. 3-5, the grinding die surface 60 is located adjacent to the grinding wheel mantle surface 54 and together thereby form a generally arcuate/arch shaped gap 66 there between. The grinding die 30 is mounted and supported adjacent the grinding wheel 28 and within the grinding head unit 20 with a pair of angles 68. The positions of the angles 68 are adjustable with adjustment bolts 70 for thereby raising and lowering the grinding die 30 relative to the grinding wheel 28, and for thereby selective decreasing and increasing the size of the gap 66 between the grinding die surface 60 and the grinding wheel mantle surface 28.

As should now be appreciated, as the grinding wheel 28 is rotated in the direction of arrows 52 and grinds insulation 12 from the bale, the insulation is forced into/received through the gap 66 whereat the insulation is further pulverized between the moving grinding wheel mantle surface 54 and the stationary grinding die surface 60 and is thereby fluffed up as needed into a low density state for maximizing the efficacy of the insulation.

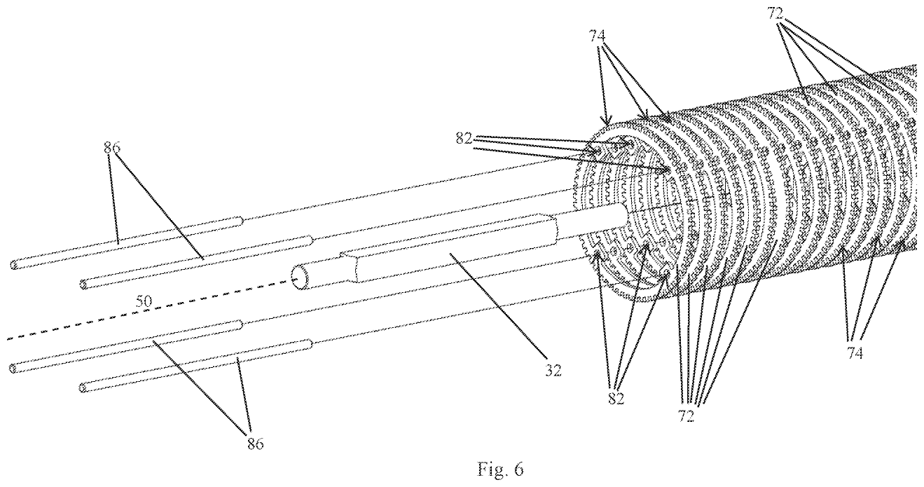

Advantageously, as best seen in FIG. 6, the grinding wheel 28 is constructed/made using a plurality of plane members 72 which are individually cut out of standard stock steel sheets (or other sheet material including aluminum, stainless steel, etc.), typically 0.125 to 0.75 inches thick, and which are stacked together/placed longitudinally against one another along and circumscribing the shaft 32 and axis of rotation 50 as, for example, shown in FIG. 11. The plane members 72 can be cut out of/from sheet stock material, for example, with laser cutting machines, oxy fuel cutting machines, plasma cutting machines and waterjet cutting machines. Each plane member 72 is cut with a unique perimeter surface shape 74. The perimeter surface 74 of each plane member 72 is radially and longitudinally aligned so that, when plane members 72 are stacked together as shown, the perimeter surfaces 74 thereof together form the grinding wheel mantel surface 54 together with the protrusions 56 and valleys/indentations 58 thereof.

Some of the plane members 72 are provided with a central opening 76. The central openings 76 are located, shaped and sized so that, when the plane members 72 are stacked, the openings 76 thereof are aligned and form a bore 78 wherethrough the shaft 32 is matingly received. Preferably the central openings 76 are noncircular shaped. For example, the central openings 76 can be square shaped as shown, thereby forming a cuboid shaped bore 78. The shaft 32 includes a central area 80 which is correspondingly square shaped, and which is adapted to be received in the cuboid bore 78 generally perpendicular to the plane members 72. Accordingly, the plane members 72 are thereby coupled to the shaft 32, and the grinding wheel 28 formed by the stacked plane members 72 is thereby rotatably driven.

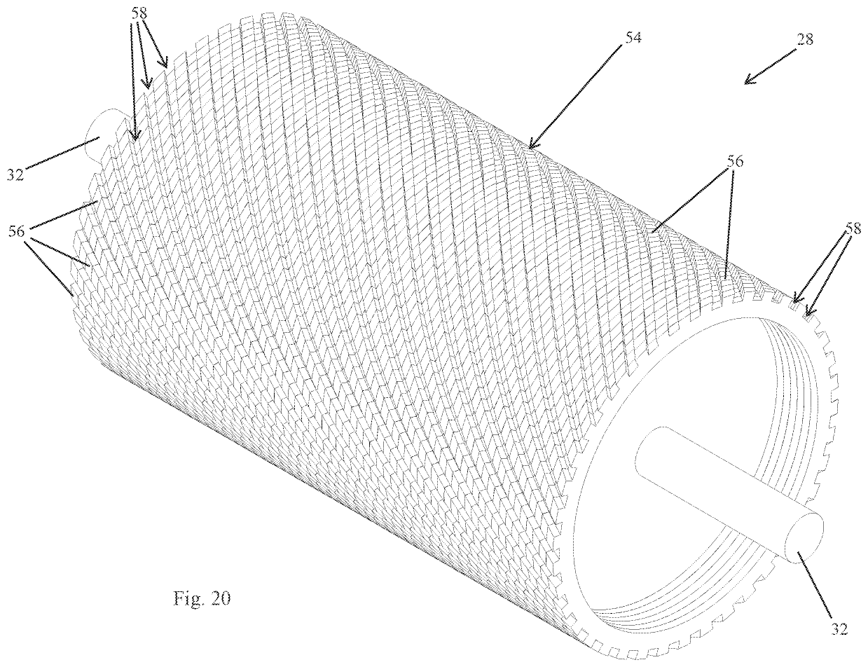

Each of the plane members 72 are provided with, preferably three to four, through holes 82 which are located near its perimeter surface 74. The holes 82 are located, shaped and sized so that, when the plane members 72 are stacked, the holes 82 thereof are aligned and form longitudinally extending bores 84 adapted to receive a coupling rod 86 therethrough. For assembling the grinding wheel 28, after the plane members 72 are stacked and longitudinally compressed as may be needed, and the holes 82 are aligned and form bores 84, the coupling rods 86 are inserted into and through the bores 84 perpendicular to the plane members 72, and the terminal ends thereof are then welded to the end plane members 72, thereby securely longitudinally fastening the plane members 72 in their stacked position as, for example, shown in FIGS. 20-25. Alternatively, the coupling rods 86 can be provided with threaded ends and mating threaded nuts (not shown) whereby the nuts can be used to compress and maintain the plane members 72 in their stacked position.

Preferably, so as to decrease the weight of the grinding wheel 28 to that which is desired for maximum performance, the plane members 72 can be provided with apertures 88 which define spokes 90 extending radially from the shaft 32/axis of rotation 50 towards the perimeter surface 74. Also preferably, near the longitudinal ends of the grinding wheel 28, plane members 72S can be provided, which are essentially a solid plate, extending radially from the shaft 32/axis of rotation 50 towards the perimeter surface 74 so as to provide additional rigidity and to prevent insulation from entering the apertures 88 between the spokes 90. Additionally, at the longitudinal ends of the grinding wheel 28, a plurality of open plane members 720 can be provided which have their entire center area removed and, hence, do not extend to the shaft 32, whereby the terminal longitudinal ends of the wheel 28 can be extended longitudinally beyond the shaft square central area 80 and adjacent the interior surface/wall of the grinding head unit 20.

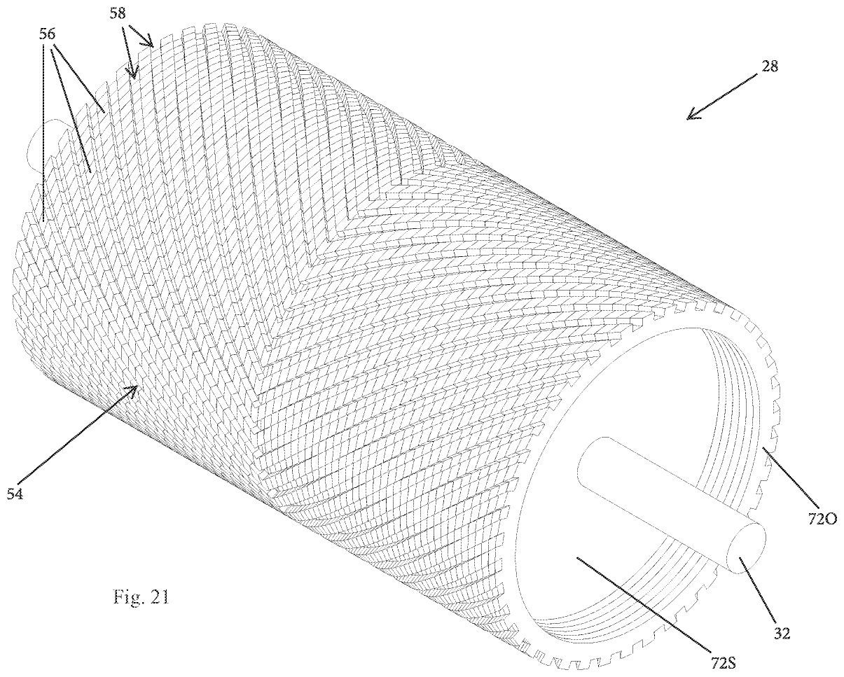

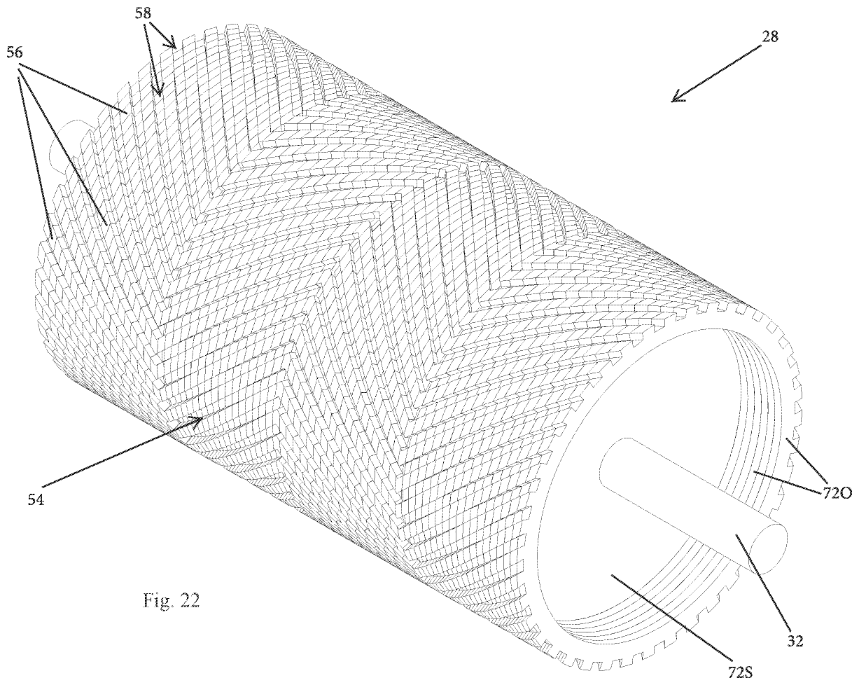

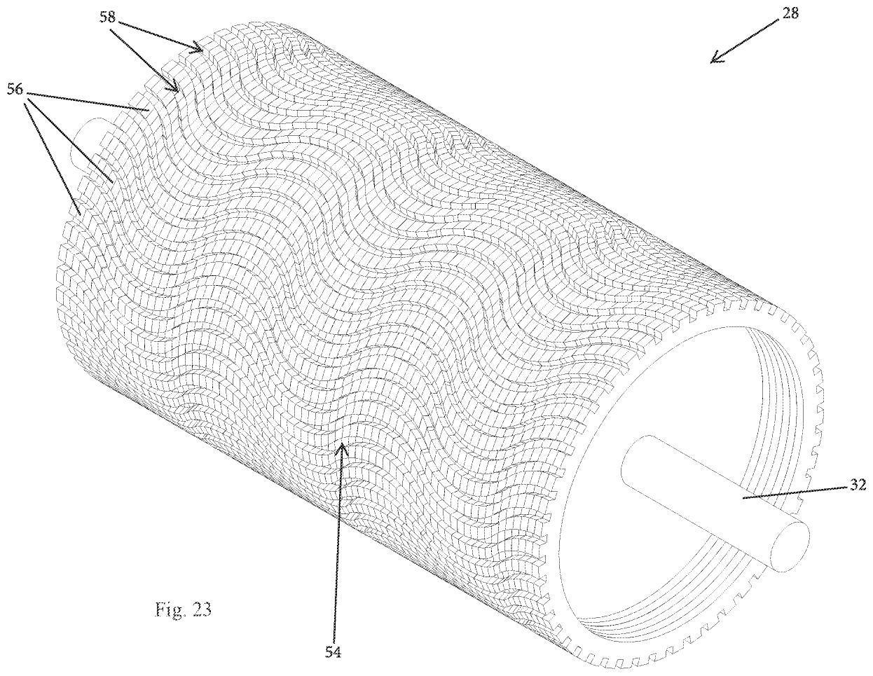

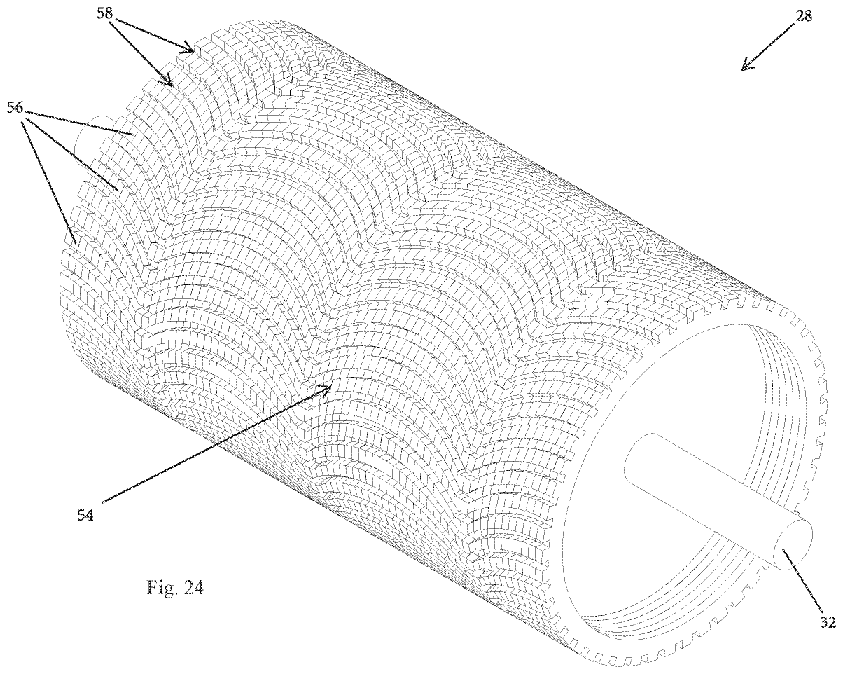

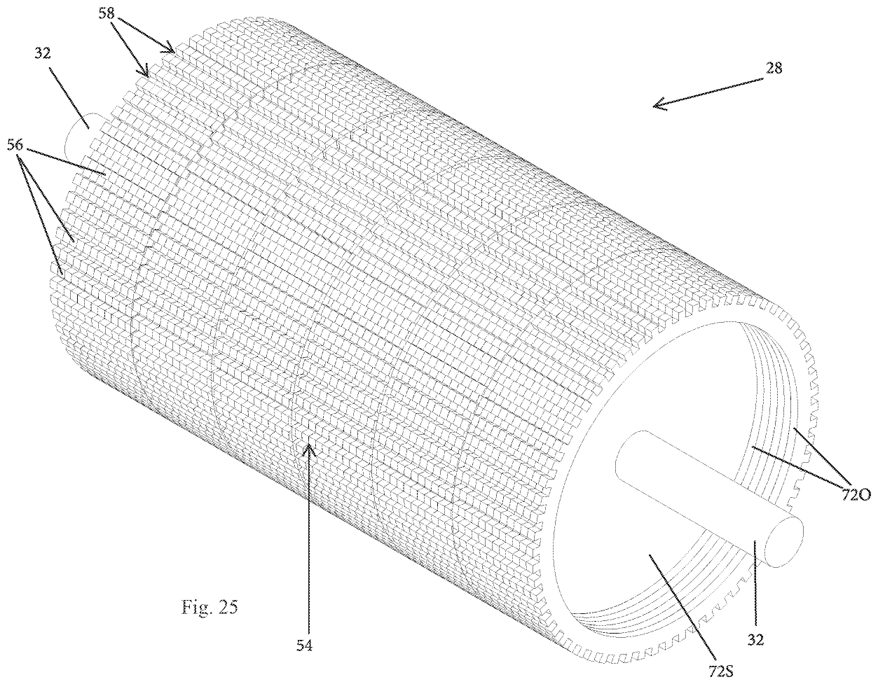

As should now be appreciated, by cutting each plane member 72 with a unique perimeter surface shape 74 and by longitudinally and radially aligning the perimeter surfaces 74 of each plane member 72, when the plane members 72 are stacked together as shown, the perimeter surfaces 74 thereof together form the grinding wheel mantel surface 54 together with the protrusions 56 and valleys/indentations 58 thereof and, further, various protrusion shapes 56 and various valley/indentation shapes 58 and cutting edges can be formed as may be needed or desired. For example, the protrusions 56 and valleys/indentations 58 on and along the grinding wheel mantle surface 54 can be formed to create one or more of a longitudinally extending spiral shape as shown in FIG. 20, a single V-shape as shown in FIG. 21, a multiple V-shape as shown in FIG. 22, a sinusoidal shape as shown in FIG. 23, a multiple arch shape as shown in FIG. 24 and a multiple staggered offset longitudinal lines shape as shown in FIG. 25.

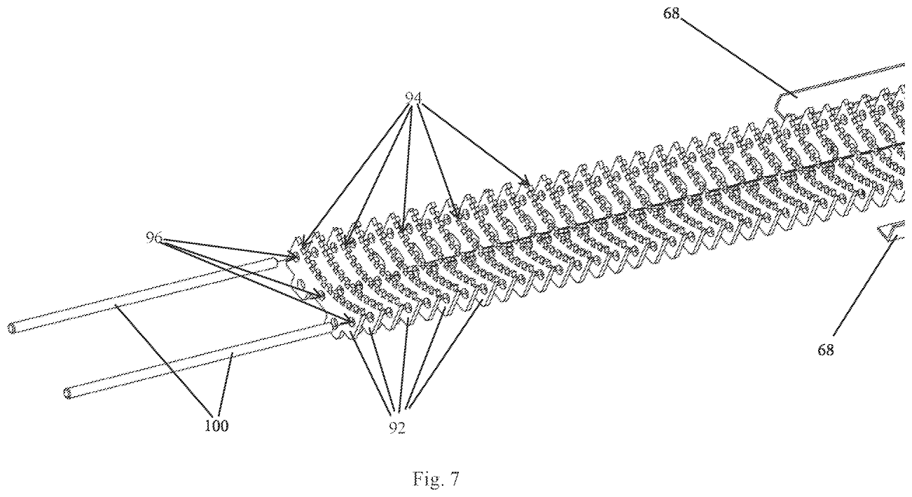

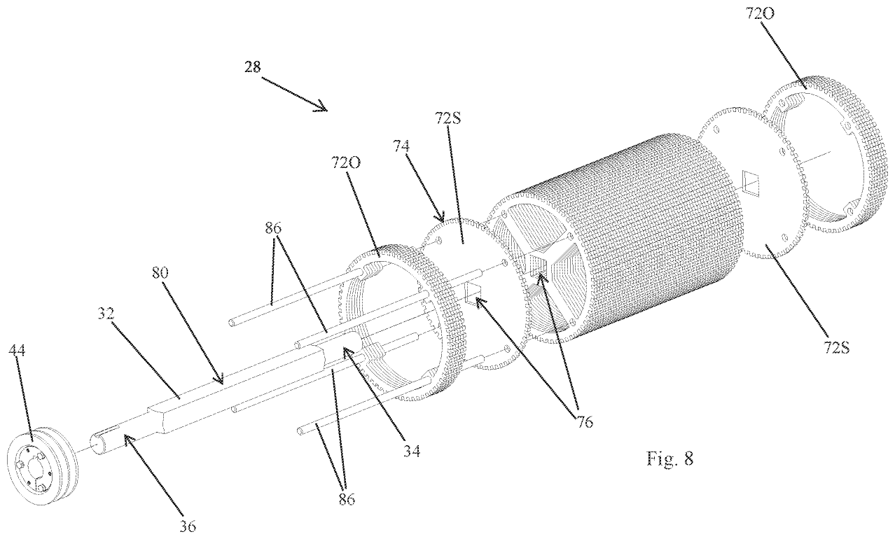

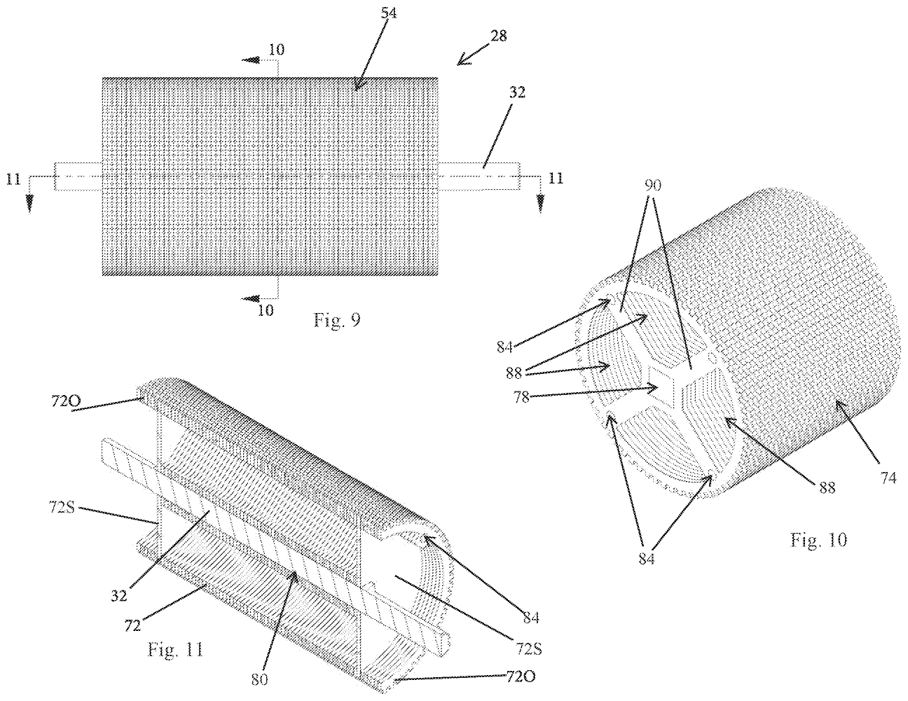

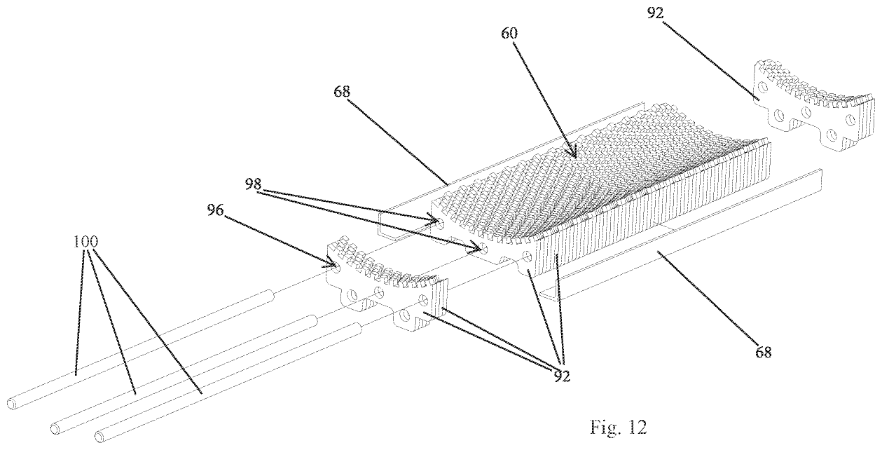

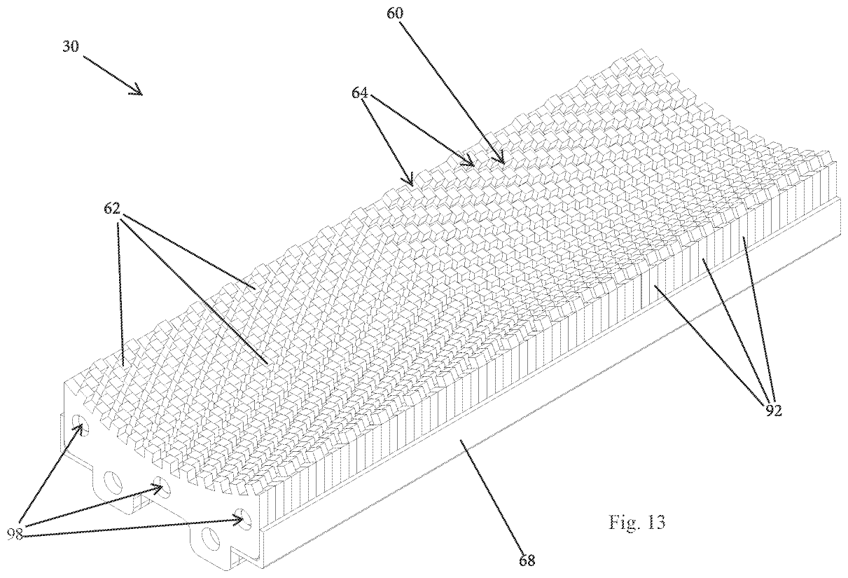

Also advantageously, as best seen in FIG. 7, the grinding die 30 is constructed/made using a plurality of die plates 92 which are individually cut out of standard stock steel sheets (or other sheet material including aluminum, stainless steel, etc.) typically 0.125 to 0.75 inches thick, and which are stacked together/placed longitudinally against one another as, for example, shown in FIGS. 13-19. The die plates 92 can be cut out of/from sheet stock material, for example, with laser cutting machines, oxy fuel cutting machines, plasma cutting machines and waterjet cutting machines. Each die plate 92 is cut with a unique abutment surface shape 94. The abutment surface 94 of each die plate 92 is aligned so that, when the die plates 92 are stacked together as shown, the abutment surfaces 94 thereof together form the grinding die surface 60 together with the protrusions 62 and valleys/indentations 64 thereof.

Each of the die plates 92 are provided with, preferably two to three, through holes 96. The holes 96 are located, shaped and sized so that, when the die plates 92 are stacked, the holes 96 thereof are aligned and form longitudinally extending bores 98 adapted to receive a coupling rod 100 therethrough. For assembling the grinding die 30, after the die plates 92 are stacked and longitudinally compressed as may be needed, and the holes 96 are aligned and form bores 98, the coupling rods 100 are inserted into and through the bores 98 perpendicular to the die plates 92, and the terminal ends thereof are then welded to the end die plates 92, thereby securely longitudinally fastening the die plates 92 in their stacked position as, for example, shown in FIGS. 13-19. Alternatively, the coupling rods 100 can be provided with threaded ends and mating threaded nuts (not shown) whereby the nuts can be used to compress and maintain the die plates 92 in their stacked position.

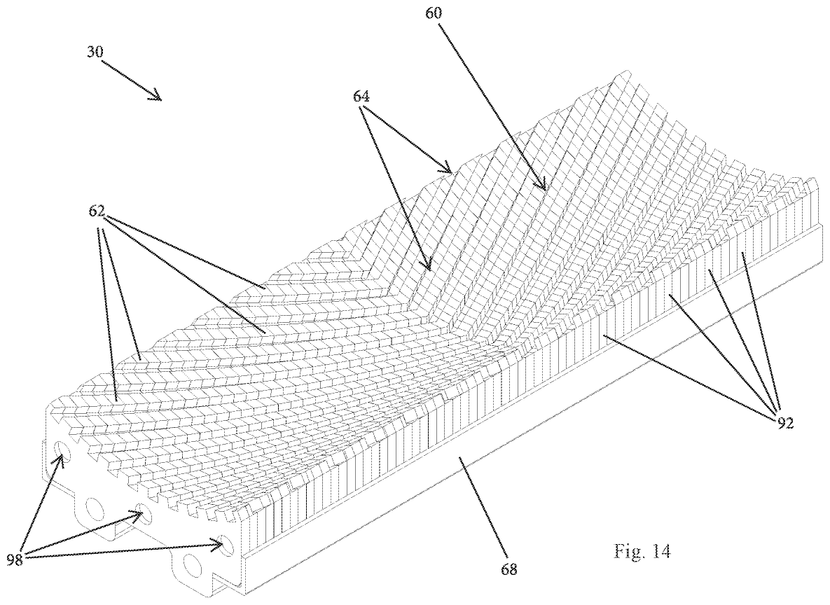

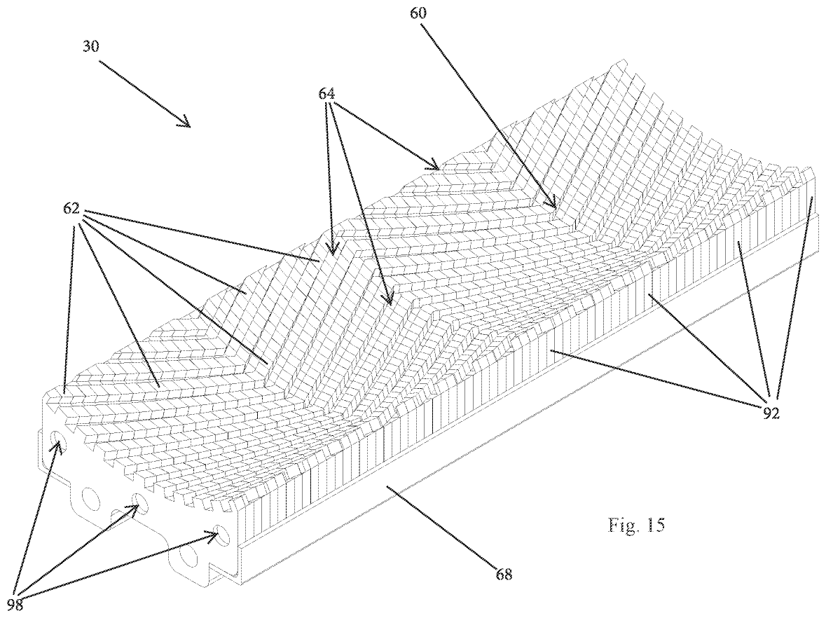

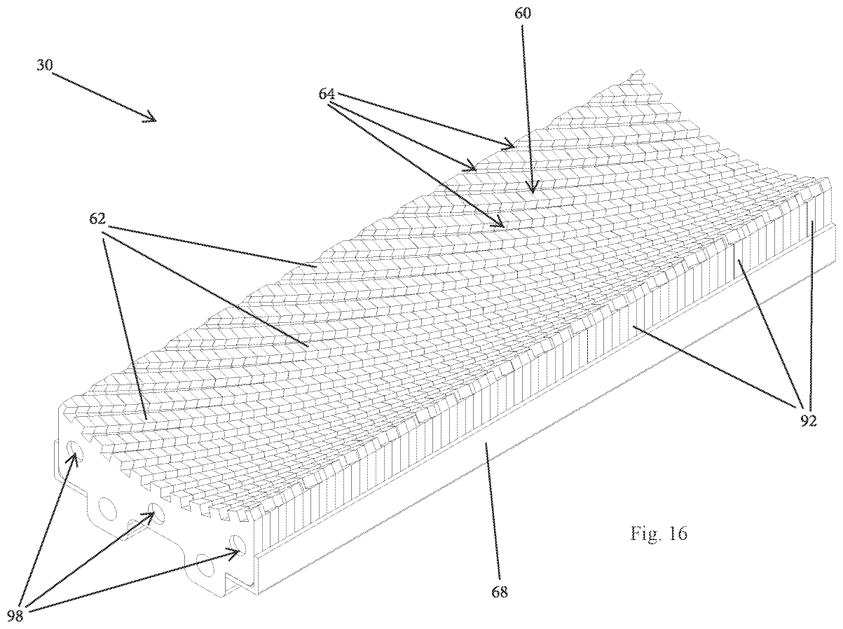

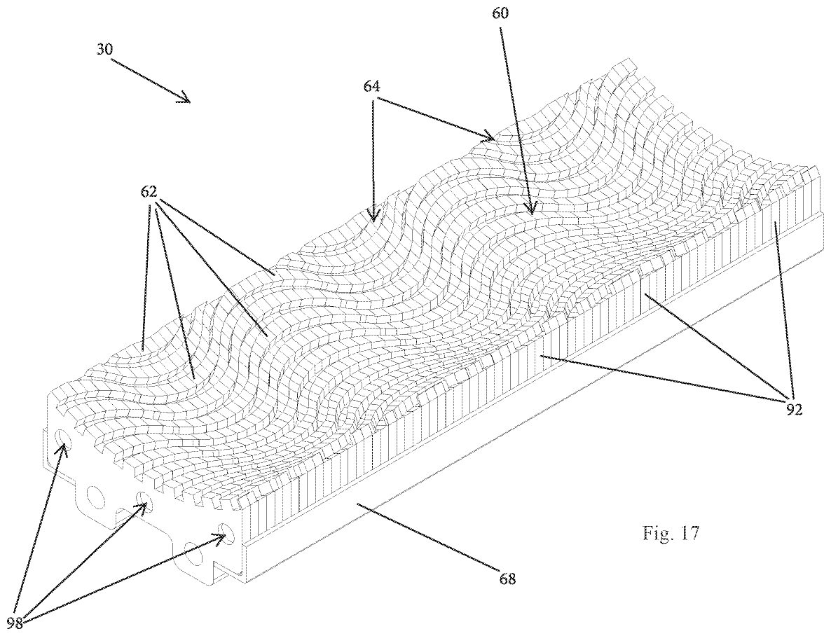

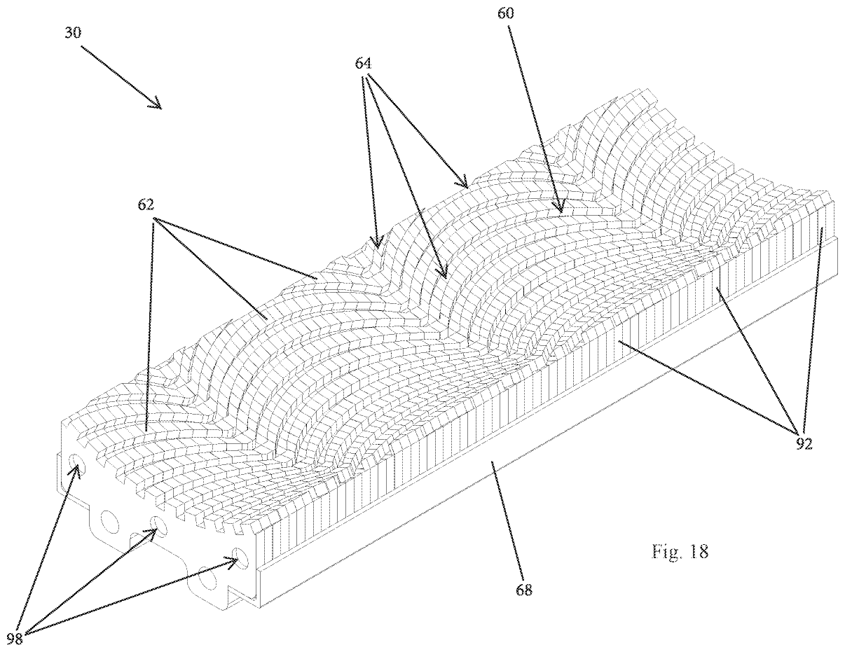

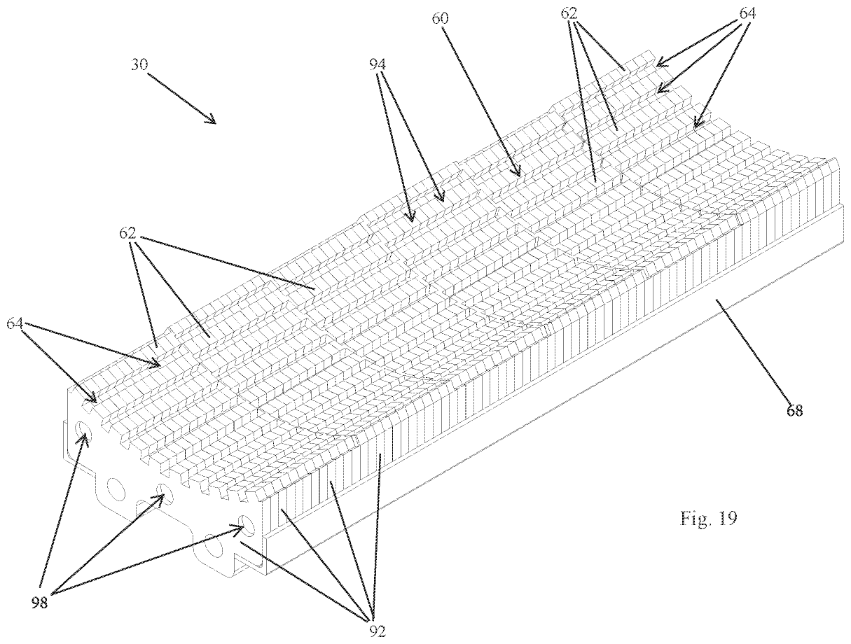

As should now be appreciated, by cutting each die plate 92 with a unique abutment surface shape 94 and by aligning the abutment surfaces 94 of each die plate 92, when the die plates 92 are stacked together as shown, the abutment surfaces 94 thereof together form the grinding die surface 60 together with the protrusions 62 and valleys/indentations 64 thereof and, further, various protrusion shapes 62 and various valley/indentation shapes 64 and cutting edges can be formed as may be needed or desired. For example, the protrusions 62 and valleys/indentations 64 on and along the grinding die surface 60 can be formed to create one or more of a V-shape with staggered protrusions as shown in FIG. 13, a V-shape as shown in FIG. 14, a multiple V-shape as shown in FIG. 15, a longitudinally extending spiral shape as shown in FIG. 16, a sinusoidal shape as shown in FIG. 17, a multiple arch shape as shown in FIG. 18 and a multiple staggered longitudinal lines shape as shown in FIG. 19.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for pulverizing compressed insulation by placing the compressed insulation in contact with a grinding wheel having a mantle surface circumscribing and being rotatable about an axis of rotation and having a plurality of protrusions arranged on the mantle surface, wherein the grinding wheel comprises:
a plurality of stacked plane members circumscribing and being rotatable about the axis of rotation;
wherein each plane member comprises a perimeter surface; and,
wherein the perimeter surfaces of the stacked plane members together form the grinding wheel mantle surface and protrusions.

2. The apparatus of claim 1 wherein some of the plane members comprise apertures defining spokes extending radially from the axis of rotation towards the perimeter surface.

3. The apparatus of claim 1 wherein some of the plane members comprise a solid plate extending from the axis of rotation towards the perimeter surface.

4. The apparatus of claim 1 further comprising a rotatably driven shaft coaxially aligned with the axis of rotation and wherein the plane members are coupled to the shaft and are thereby rotatably driven.

5. The apparatus of claim 4 further comprising a plurality of coupling rods extending perpendicular to and through aligned holes in the plurality of stacked plane members whereby the plane members are retained in their stacked position.

6. The apparatus of claim 5 wherein the plane members are formed by cutting out of flat steel material.

7. The apparatus of claim 6 wherein the perimeter surface of each stacked plane member is arranged relative to the perimeter surfaces of the other stacked plane members whereby the protrusions on and along the mantle surface form one or more of a spiral shape, a V-shape, a multiple V-shape, a sinusoidal shape, a multiple arch shape and a multiple staggered longitudinal lines shape.

8. The apparatus of claim 1 further comprising a rotatably driven shaft coaxially aligned with the axis of rotation, wherein the shaft extends perpendicular to and through aligned openings in the plurality of stacked plane members, whereby the plane members are coupled to the shaft and are thereby rotatably driven.

9. The apparatus of claim 8 wherein some of the aligned openings of the plane members comprise a noncircular shape and wherein the shaft includes a mating noncircular shape portion, whereby the plane members are coupled to the shaft.

10. The apparatus of claim 1 further comprising a plurality of coupling rods extending perpendicular to and through aligned holes in the plurality of stacked plane members whereby the plane members are retained in their stacked position.

11. The apparatus of claim 1 wherein the plane members are formed by cutting out of flat steel material.

12. The apparatus of claim 1 wherein the perimeter surface of each stacked plane member is arranged relative to the perimeter surfaces of the other stacked plane members whereby the protrusions on and along the mantle surface form one or more of a spiral shape, a V-shape, a multiple V-shape, a sinusoidal shape, a multiple arch shape and a multiple staggered longitudinal lines shape.

13. The apparatus of claim 1 wherein some of the plane members comprise apertures defining spokes extending radially from the axis of rotation towards the perimeter surface; some of the plane members comprise a solid plate extending from the axis of rotation towards the perimeter surface; and, further comprising a rotatably driven shaft coaxially aligned with the axis of rotation and wherein the plane members are coupled to the shaft and are thereby rotatably driven.

14. The apparatus of claim 13 further comprising a plurality of coupling rods extending perpendicular to and through aligned holes in the plurality of stacked plane members whereby the plane members are retained in their stacked position.

15. The apparatus of claim 14 wherein the plane members are formed by cutting out of flat steel material.

16. The apparatus of claim 15 wherein the perimeter surface of each stacked plane member is arranged relative to the perimeter surfaces of the other stacked plane members whereby the protrusions on and along the mantle surface form one or more of a spiral shape, a V-shape, a multiple V-shape, a sinusoidal shape, a multiple arch shape and a multiple staggered longitudinal lines shape.

17. The apparatus of claim 1 further comprising a grinding die having a die surface with a plurality of die protrusions arranged thereon, wherein the die surface and the grinding wheel mantle surface are adjacent one another and form a gap therebetween wherethrough insulation is received and is further pulverized, the grinding die comprising:
a plurality of stacked die plates;
wherein each die plate comprises an abutment surface; and,
wherein the abutment surfaces of the stacked die plates together form the grinding die surface and protrusions.

18. The apparatus of claim 17 further comprising a plurality of coupling rods extending perpendicular to and through aligned holes in the plurality of stacked die plates whereby the die plates are retained in their stacked position.

19. The apparatus of claim 17 wherein the die plates are formed by cutting out of flat steel material.

20. The apparatus of claim 17 wherein the abutment surface of each stacked die plate is arranged relative to the abutment surfaces of the other stacked die plates whereby the protrusions on and along the die surface form one or more of a V-shape, a V-shape with staggered protrusions, a multiple V-shape, a spiral shape, a sinusoidal shape, a multiple arch shape and a multiple staggered longitudinal lines shape.

21. The apparatus of claim 17 further comprising a rotatably driven shaft coaxially aligned with the axis of rotation and wherein the plane members are coupled to the shaft and are thereby rotatably driven.

22. The apparatus of claim 21 further comprising: a plurality of coupling rods extending perpendicular to and through aligned holes in the plurality of stacked plane members whereby the plane members are retained in their stacked position; and, a plurality of coupling rods extending perpendicular to and through aligned holes in the plurality of stacked die plates whereby the die plates are retained in their stacked position.

23. The apparatus of claim 22 wherein the plane members and the die plates are formed by cutting out of flat steel material.

24. The apparatus of claim 23 wherein the perimeter surface of each stacked plane member is arranged relative to the perimeter surfaces of the other stacked plane members whereby the protrusions on and along the mantle surface form one or more of a spiral shape, a V-shape, a multiple V-shape, a sinusoidal shape, a multiple arch shape and a multiple staggered longitudinal lines shape; and, further wherein the abutment surface of each stacked die plate is arranged relative to the abutment surfaces of the other stacked die plates whereby the protrusions on and along the die surface form one or more of a V-shape, a V-shape with staggered protrusions, a multiple V-shape, a spiral shape, a sinusoidal shape, a multiple arch shape and a multiple staggered longitudinal lines shape.
